(19) United States
(12) Patent Application Publication
(10) Pub. No.: US 2023/0380020 A1
(43) Pub. Date: Nov. 23, 2023

(54) SYSTEM COMPRISING A DEVICE AND OPERATING ELEMENT

(71) Applicant: BULTHAUP GMBH & CO. KG, Aich, Bodenkirchen (DE)

(72) Inventor: Marc Oliver ECKERT, Bodenkirchen (DE)

(21) Appl. No.: 17/913,358

(22) PCT Filed: Mar. 22, 2021
(86) PCT No.: PCT/EP2021/057175

§ 371 Date: Sep. 21, 2022

(30) Foreign Application Priority Data
Mar. 25, 2020 (DE) 10 2020 108 194.4

(51) Int. Cl. H05B 6/06

(52) U.S. Cl. CPC H05B 6/062

(57) ABSTRACT

The present invention relates to a system having a furnishing element and an operating part, wherein the furnishing element has a work surface and is designed to carry out at least one process, and wherein the operating part is designed such that the process of the furnishing element is carried out depending on the position of the operating part with respect to the furnishing element, wherein the operating part is freely placeable relative to the furnishing element, and a sensor system is provided that detects the presence of the operating part on the work surface and actuates the process of the furnishing element depending on this detection.

The present invention relates to a system having a furnishing element and an operating part, wherein the operating part is freely placeable relative to the furnishing element, and a sensor system is also provided that detects the presence of the operating part on the work surface and enables the process of the furnishing element depending on this detection.

Conventionally, furnishing elements such as hobs are operated via rotary knobs. This has the disadvantage that not only does the aesthetic appearance of a kitchen suffer, but also the space required by the hob is taken up by a Ceran hob, for example, and thus cannot otherwise be used as a work surface.

Against this background, the object underlying the present invention is to mitigate or even completely eliminate the disadvantages of the prior art.

This object is achieved by a system having a furnishing element and an operating part according to claim 1 and an item of kitchen furniture according to claim 13.

A system according to the invention comprises a furnishing element and an operating part, wherein the furnishing element has a work surface and is designed to carry out at least one process, and wherein the operating part (also referred to as an operating element) is designed such that the process of the furnishing element is carried out depending on the position of the operating part with respect to the furnishing element, wherein the operating part is freely placeable relative to the furnishing element, and a sensor system is provided that detects the presence of the operating part on the work surface and enables the process of the furnishing element depending on this detection.

For example, the furnishing element can be a hob integrated into a work surface and the operating element can be a sheet that is modelled on the shape of a hotplate.

If the sheet is placed on the work surface, the sensor system detects that the sheet is resting on the work surface and the “heat generation” process is unlocked, preferably locally in the area of the placed sheet. Heat is thus generated in the area of the placed sheet and a cooking utensil, for example a pot, can be placed on the sheet for cooking.

If the sheet is removed from the work surface, heat is also no longer generated and the work surface can be used completely flexibly for other activities. This increases the efficiency of the use of space and the flexibility in the design of the kitchen.

However, the operating element is not limited to the process of “heat generation”. For example, the operating element can also be designed to control the process of “cold generation” or even to unlock a power supply of another functional element, such as an extractor hood, a socket or a refrigerator. The functional element is not limited to these examples, but can be designed to carry out any function.

Preferably, the functional element is integrated in the operating element. For example, the operating element has a socket, which conducts current as soon as the operating element comes to rest on the work surface of the furnishing element.

Alternatively to this, the functional element can be an extractor fan, which goes into standby mode when the operating element comes to rest on the work surface of the furnishing element and the process of “suction” is unlocked. The operation of the functional element can be set by means of a user interface on the side of the operating element or the furnishing element.

Preferably, the operating element has a flat design; for example, in the form of a sheet or of a rectangle or square. The shape of the operating element is arbitrary as long as a flat design is provided that allows the operating element to be placed in a stable support on the furnishing element and a cooking utensil, for example a pot, to be placed securely on a side of the operating element facing away from the furnishing element.

In practice, it has proven to be advantageous if the operating element and/or the furnishing element has a user interface, by means of which a user can set the process to be carried out by the furnishing element.

For example, the intensity of the process, e.g. the temperature, the duration of the process, the area on which the process is to be carried out (e.g. “small worktop” or “large worktop”) can be set. For example, by touching the user interface, the user can adjust individual parameters of the process continuously or in steps.

The user interface is preferably coupled to a control unit, which activates the operating element in accordance with the user's input.

It is also conceivable that the operating element has a user interface, which is detachably connected to the operating element. For example, the user interface can be plugged into the operating element and releasably latched to it.

It has also proven to be advantageous if the operating element and/or the furnishing element has a display unit, which is designed to provide feedback to a user regarding a process (to be) carried out by the furnishing element.

For example, the display unit can show the temperature and/or duration of a heat generation process. Numbers, letters, color codes or scales (e.g. multiple markings) can be used to indicate a predetermined parameter of a process (to be) carried out by the furnishing element.

The furnishing element can further have at least one region that is designed such that the placement of the operating part on this area does not activate any processes of the furnishing element. For example, the furnishing element can have area region that is designed to carry out a process, in particular designed to generate heat when the operating element is placed on the area, and another area in which the placement of the operating element on this area does not trigger heat generation.

A further aspect of the present invention relates to a system according to any one of the preceding claims, characterized in that a sensor system is provided on the side of the operating element and/or the furnishing element, which sensor system detects a relative position of the operating element with respect to the furnishing element, in particular a rotational position of the operating element on the work surface of the furnishing element, and sets the process (to be) carried out by the furnishing element depending on the relative position detected.

For example, the operating element can be rotated or moved on the work surface to adjust the temperature of the heat generated or another parameter of the process.

Preferably, the sensor system is designed to continuously detect the relative position of the operating element to the furnishing element and preferably also to continuously adjust parameters of the process.

In one form of application of a system according to the invention, the furnishing element is a means for generating heat or is a hob, wherein the work surface is preferably made of stone, glass, wood, ceramic, metal or plastic, or has one or more of these materials.

Furthermore, it has proven to be advantageous in practice if the operating element and/or the furnishing element has a positioning element, which is designed to position and/or releasably hold the operating element in a predetermined relative position to the furnishing element, preferably on the work surface. For example, the positioning element can have a protrusion and a corresponding recess or even magnets. The positioning element can take the form of a marking on the operating element and/or the furnishing element.

The positioning element can be designed so as to hold the operating element on the furnishing element until the work surface has cooled down; for example, after a process for generating heat, to such an extent that there is no risk of injury to a user.

To increase the user safety, a system according to the invention can further have a control sensor system, which is designed to recognize a functional element, in particular a cooking utensil, arranged on the furnishing element, and to enable the process (to be) carried out by the furnishing element locally limited in an area of the operating element and/or furnishing element corresponding substantially to the base area of the functional element.

For example, the control sensor system can be designed to activate magnetic coils in the work surface only locally under a cooking utensil to generate heat. This avoids there being empty hot surfaces and also prevents a magnetic field generated by the magnetic coils from spreading outside the surface of the operating element and/or cooking utensil.

Preferably, the operating element is at least in part made from stone (e.g. cordierite, soapstone), artificial stone (e.g. Inalco), wood, metal, ceramic, porcelain or plastic (e.g. PI, PAI, PEEK). Composites, e.g. Kelutherm, sintered ceramic, are also conceivable. In particular, one side of the operating element, which is designed to face away from a work surface of the furnishing element and to be brought into contact with, for example, a cooking utensil, has a uniform surface made of one of the materials listed.

On one side, which is designed to be brought into contact with the work surface of the furnishing element, the operating element preferably has a layer for thermal insulation. Preferably, the layer for thermal insulation is designed in such a way that temperatures of no more than 80° C. occur at the interface between the operating element and the work surface of the furnishing element.

The layer for thermal insulation allows the work surface of the furnishing element to be made of temperature-sensitive materials, for example wood.

The operating element preferably has a layer for thermal insulation, which preferably comprises ceramic and/or ceramic fiber material and/or at least one ceramic plate and/or a vacuum panel.

The operating element can further have at least one thermal separator that, for example, has glass ceramic, at least one glass rod and/or at least one high-temperature plastic. The thermal separator is preferably arranged between a side of the operating element that is designed to be brought into contact with the work surface of a furnishing element (thermally insulating layer) and a side of the operating element that is designed to be brought into contact with a cooking utensil.

A further aspect of the present invention relates to an item of furniture, in particular an item of kitchen furniture, having at least one system according to any one of the preceding claims.

Further features, effects and advantages of the present invention result from the following description of selected embodiments with reference to the figures, in which the same or similar components are designated with the same reference numerals. In the figures:

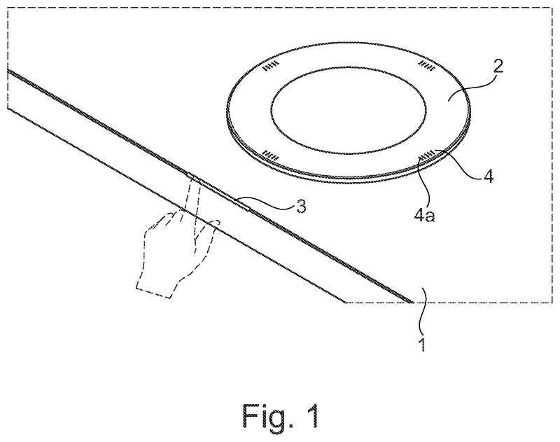

FIG. 1 shows an embodiment of the invention with a sheet-shaped operating element,

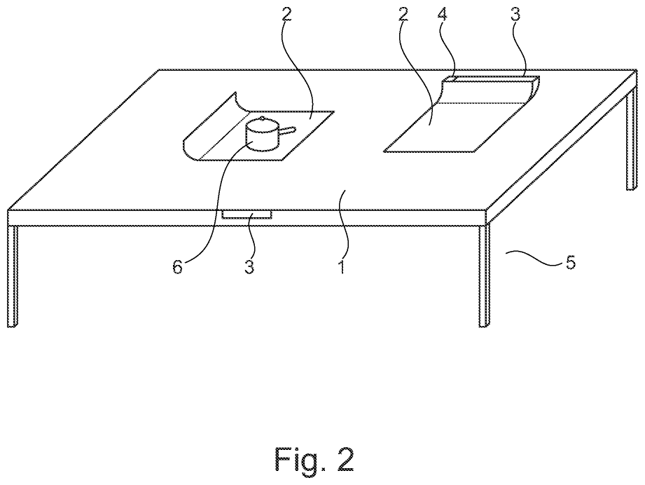

FIG. 2 shows an embodiment of the invention with two rectangular operating elements,

FIG. 1 shows a worktop 1 of a furnishing element, on which a sheet-shaped operating element 2 rests. The worktop is made of wood or stone, for example.

In the present example, the furnishing element is a hob. The furnishing element has a user interface 3, by means of which a user can control, for example by touching the user interface 3, the temperature and/or duration of heat generation by the hob integrated in the worktop 1.

The sheet-shaped operating element 2 has a display unit 4, which gives the user feedback on the heat generation process carried out. For example, the number of illuminated markings 4a can reflect the temperature level (to be) generated.

Alternatively or additionally, the display unit 4 can also use colors to signal whether heat is generated (e.g. a red light) and/or whether a specified target temperature has been reached (e.g. a green light).

The operating element also has wood or stone on its surface, for example.

FIG. 2 shows an embodiment of the invention with two rectangular operating elements 2, which rest on a worktop 1 of a furnishing element 5. In this embodiment, the operating elements 2 each have the shape of a rectangular panel, which is bent up or curved on one side.

A pot 6 is arranged on the left-hand side of the operating element 2. The temperature for the cooking process can, for example, be regulated via the user interface 3 of the furnishing element 5.

Alternatively or additionally, as shown with the operating element 2 on the right-hand side in FIG. 2, a user interface 3 can be releasably connected to the operating element 2. Preferably, the user interface 3 is releasably connected to the bent-up edge of the operating element 2; for example, by means of a plug connection or other positive or non-positive connection.

A display unit 4 can also be provided on the bent-up edge of the operating element 2, which display unit is preferably also releasably arranged there and is preferably integrated with the user interface 3.

Instead of or additionally to the user interface 3 on the operating element 2, a control unit can also be provided, which activates the operating element depending on the instructions entered by means of a user interface on the side of the operating element 2 or on the side of the furnishing element 5.

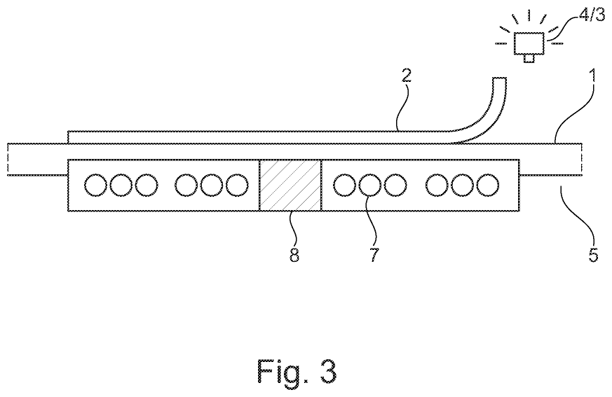

FIG. 3 shows a sectional view of a furnishing element 5 and of an operating element 2 resting on the worktop 1 thereof. A hob with a plurality of coil units 7 for generating a magnetic field and heat is embedded in the worktop 1. A positioning element 8, in this embodiment, for example, an electromagnet, is arranged in the center of the hob and holds the operating element 2 securely in position above the hob. The operating element has a positioning element (not shown) that is designed to interact with the electromagnet 8 to hold the operating element 2 on the work surface 1.

By means of a unit 3, 4 of a control unit and a display unit 4 integrated therein, the operation of the operating element 2 is controlled and the user is informed thereof. In FIG. 3, the unit 3, 4 is shown separated from the operating element 2; however, it is usually connected to the operating element during operation.

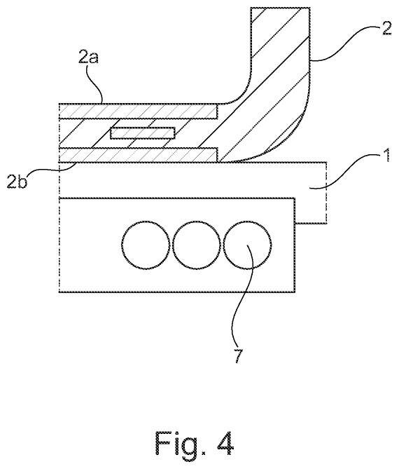

FIG. 4 shows an enlarged detail of the sectional view from FIG. 3, in which in particular the layered structure of the operating element 2 can be seen. In this embodiment, the operating element 2 has a first contact surface 2a, which is designed to come into contact with a cooking utensil. The contact surface 2a is made from a heat-resistant material; for example, glass, ceramic, glass ceramic, stone or metal.

The operating element 2 further has a second contact surface 2b, which is designed to come into contact with the work surface 1. The contact surface 2b is made from a thermally insulating material and protects the material of the work surface 1 (for example wood) from being damaged by hot cooking utensils.

1. System having a furnishing element and an operating part, wherein
the furnishing element has a work surface and is designed to carry out at least one process,
the operating part is designed such that the process of the furnishing element is carried out depending on the position of the operating part relatively to the furnishing element,
the operating part is freely placeable relative to the furnishing element, and
a sensor system is provided that detects the presence of the operating part on the work surface and enables the process of the furnishing element depending on this detection.

2. System according to claim 1, wherein the operating element has a flat design, preferably in the form of a sheet or of a rectangle or square.

3. System according to claim 1, wherein the operating element and/or the furnishing element has a user interface, by which a user can set the process to be carried out by the furnishing element.

4. System according to claim 3, wherein the operating element has a user interface, which is detachably connected to the operating element.

5. System according to claim 1, wherein the operating element and/or the furnishing element has a display unit, which is designed to provide feedback to a user regarding a process to be carried out by the furnishing element.

6. System according to claim 1, wherein the furnishing element has at least one area that is designed such that the placement of the operating part on this area does not activate any processes of the furnishing element.

7. System according to claim 1, wherein a sensor system is provided on the side of the operating element and/or the furnishing element, which sensor system detects a relative position of the operating element with respect to the furnishing element, in particular a sliding or rotational position of the operating element on the work surface of the furnishing element, and sets the process to be carried out by the furnishing element depending on the relative position detected.

8. System according to claim 6, wherein the sensor system is designed to continuously detect the relative position of the operating element to the furnishing element.

9. System according to claim 1, wherein the furnishing element has means for generating heat or is a hob, and the work surface is preferably made of stone, wood, ceramic, metal or plastic.

10. System according to claim 1, wherein the operating element and/or the furnishing element has a positioning element, which is designed to position and/or releasably hold the operating element in a predetermined relative position to the furnishing element, preferably on the work surface.

11. System according to claim 1, further having a control sensor system, which is designed to recognize a functional element, in particular a cooking utensil, arranged on the furnishing element, and to enable the process to be carried out by the furnishing element locally limited in an area of the operating element and/or the furnishing element corresponding substantially to the base area of the functional element.

12. System according to claim 1, wherein the operating element is at least in part made from stone, wood, metal, ceramic or plastic and preferably has a thermal insulation layer on a side designed to be brought into contact with the work surface of the furnishing element.

13. Item of furniture, in particular item of kitchen furniture, having at least one system according to claim 1.

14. System according to claim 2, wherein the operating element and/or the furnishing element has a user interface, by which a user can set the process to be carried out by the furnishing element.

15. System according to claim 14, wherein the operating element has a user interface, which is detachably connected to the operating element.

16. System according to claim 15, wherein the operating element and/or the furnishing element has a display unit, which is designed to provide feedback to a user regarding a process to be carried out by the furnishing element.

17. System according to claim 14, wherein the operating element and/or the furnishing element has a display unit, which is designed to provide feedback to a user regarding a process to be carried out by the furnishing element.

18. System according to claim 4, wherein the operating element and/or the furnishing element has a display unit, which is designed to provide feedback to a user regarding a process to be carried out by the furnishing element.

19. System according to claim 3, wherein the operating element and/or the furnishing element has a display unit, which is designed to provide feedback to a user regarding a process to be carried out by the furnishing element.

20. System according to claim 2, wherein the operating element and/or the furnishing element has a display unit, which is designed to provide feedback to a user regarding a process to be carried out by the furnishing element.
